(19) United States
(12) Patent Application Publication
(10) Pub. No.: US 2015/0153588 A1
(43) Pub. Date: Jun. 4, 2015

(54) CONTACT LENS WITH SPATIALLY HETEROGENOUS SURFACE PATTERNS FOR IMPROVED LUBRICITY

(71) Applicants: UNIVERSITY OF FLORIDA RESEARCH FOUNDATION, INC., GAINESVILLE, FL (US); ALCON RESEARCH, LTD., DULUTH, GA (US)

(72) Inventors: Thomas Ettore Angelini, Gainesville, FL (US); Wallace Gregory Sawyer, Gainesville, FL (US); David Meadows, Colleyville, TX (US); Howard Ketelson, Fort Worth, TX (US)

(21) Appl. No.: 14/414,458

(22) PCT Filed: Jul. 12, 2013
(86) PCT No.: PCT/US2013/050313

§ 371 Date: Jan. 13, 2015

Related U.S. Application Data
(60) Provisional application No. 61/671,373, filed on Jul. 13, 2012.
(60) Provisional application No. 61/783,154, filed on Mar. 14, 2013.

(51) Int. Cl. G02C 7/04

(52) U.S. Cl. CPC G02C 7/049; G02C 2202/06

(57) ABSTRACT

A surface patterned contact lens is composed of a silicon hydrogel and has one or more surface regions that are patterned with nano-scale roughness features, micro-wells, micro-protrusions, and/or micro-channels. The micro-wells, micro-protrusions, and/or micro-channels have depths and heights that are on nanometer dimensions. The nano-scale roughness features have dimensions less than 200 nm in width, depth or height. The surface patterns do not diffract light and do not inhibit the clarity that can be detected by the eye. A method of preparing the surface patterned contact lens involves molding, where a complementary negative of the surface patterned contact lens is displayed by the mold.

### CROSS-REFERENCE TO RELATED APPLICATIONS

The present application claims the benefit of U.S. Provisional Application Ser. No. 61/671,373, filed Jul. 13, 2012, and U.S. Provisional Application Ser. No. 61/783,154, filed Mar. 14, 2013, the disclosures of which are incorporated by reference herein in their entirety, including any figures, tables, or drawings.

### BACKGROUND OF INVENTION

A wide range of bulk and surface chemistries are employed to optimize specific aspects of contact lens function. For example, silicones are used for improved oxygen transport, and hydrophobic, hydrophilic, or ionic moieties are used to control wetting of mucins, lipids, oils, and aqueous fluids. These chemistries directly alter the contact's properties, for example, wettability, on both sides of the contact lens. Optimizing the chemistries for one property can reduce the quality of other properties. Often that which improves bulk properties, such as transport, can adversely affect surface properties, yet optimization of all properties is desired for use with comfort.

The comfort of silicone-based contact lenses can be improved through the addition of high water content surface gel layers, such as those employed in the Dailies Totall® lens. In these lenses, the friction coefficients at the surface have been measured to give values below mu=0.01 under boundary lubrication. The detailed physical and molecular mechanisms responsible for this dramatically increased lubricity are not yet understood and are currently being explored. A key material property of the high water content surface gel layer is the very low elastic modulus, which is approximately 10 kPa at the surface, but rises to values approaching 200 kPa under compressive loading. Additionally, a hydrogel with this level of softness will compress substantially if persistent pressure is applied. The estimated 1 kPa pressure applied by the eyelid as it sits still on the contact lens for several seconds between blinks may be enough to force the gel to collapse. Moreover, depending on the fit, the pressure at the edges of the contact lens-cornea interface may be even higher and clearly persists over significantly longer times. The friction coefficient of the collapsed surface gel under boundary lubrication conditions has been measured; it is between 10 to 100 times higher than the fully swelled gel under hydrodynamic lubrication.

It is unclear exactly as to where the primary source of lubrication based discomfort originates in contact lenses. To date there are two primary hypotheses: 1) the nerve beds on the cornea, and 2) the nerves on the underside of the eyelid. The friction-based discomfort on the cornea/contact-lens surface may be mitigated by reducing contact pressures and increasing hydration (both things addressed in the Dailies Totall® lens). Under blinking conditions, the eyelid is hydrodynamically separated from the contact lens. However, at each blink cycle there is a significant shear that must be overcome to initiate motion. This break-loose friction is a major source of damage in soft materials. Additionally, it is likely to be a primary irritation of the nerve-beds in the under-side of the eyelid.

### SUMMARY OF THE INVENTION

An embodiment of the invention is directed to hydrogel or silicon hydrogel contact lenses patterned with one or more surface regions that have a multiplicity of nano-scale roughness features, micro-wells, micro-protrusions, or micro-channels. The micro-wells, micro-protrusions, and/or micro-channels have a depth or height of about 20 to about 200 nm and dimensions parallel to the surface that have dimensions of about 100 μm or less. The nano-scale roughness features have dimensions of 10 to 200 nm parallel and perpendicular to the surface. The various surface regions can be situated on different sites on the contact lenses to optimize comfort during use of the contact lenses. The surface region at the periphery of the top surface of the contact lens, distal to the eye when worn, can be patterned with the micro-wells. The surface region at the center of the top surface can be pattered with nano-scale roughness features. The surface regions at the under-side the contact lens, proximal to the eye when worn, can be patterned with regions that have nano-scale roughness features, micro-wells, nano-protuberances, or microchannels.

Another embodiment of the invention is directed to a method of preparing a surface patterned contact lens. Inner and outer molds are provided with surface regions that are patterned with the complementary features to the nano-scale roughness features, micro-wells, micro-protrusions, or micro-channels. The molds are filled with hydrogel or silicon hydrogel precursors cast on either or both of the inner or outer mold, whereupon, after positioning the complementary outer or inner mold to provide the shape of the contact lenses, curing the hydrogel or silicon hydrogel precursors results in surface patterned hydrogel or silicon hydrogel lenses.

### BRIEF DESCRIPTION OF DRAWINGS

FIG. 1 shows a prior art contact lens, where the surface of the lens is smooth and friction forces imposed by blinking can be high when the lens is used on an eye.

FIG. 2 show a contact lens that has a variety of topographical features in different regions of the lens, according to an embodiment of the invention.

FIG. 3 shows an array of micro-scale wells that function as fluid capturing depressions for regions of the contact lenses, according to an embodiment of the invention.

FIG. 4 shows the array of micro-scale wells of FIG. 3 with entrapped fluid supporting a mass.

FIG. 5 shows the mechanism by which the micro-well array with the supported mass results in increased lubricity and reduced friction, where the supported mass changes from a) stationary to b) in motion as during the blink of an eye.

FIG. 6 shows an array of protuberances that reside in a region of the lenses, according to an embodiment of the invention.

FIG. 7 shows a portion of the contact lens with nanoscale surface roughness features where three-dimensional features extend from the surface of the contact lens, according to an embodiment of the invention.

FIG. 8 shows atomic force microscopy images of a polymer surface after being plasma etched for 1 minute at a) 10W and b) 40W to create nano-scale roughness that can be imparted as a mold to a contact lens, according to an embodiment of the invention.

FIG. 9 shows atomic force microscopy images of a polymer surface after being plasma etched for 5 minutes at a) 10W and b) 40W to create nano-scale roughness that can be imparted as a mold to a contact lens, according to an embodiment of the invention.

FIG. 10 shows plots of surface roughness versus time for 7W, 10W, and 40W plasma etches of a polymer surface.

FIG. 11 is a photograph of a smooth hydrogel surface (left) and a nano-scale roughened hydrogel surface (right), according to an embodiment of the invention, which is wetted with water.

### DETAILED DISCLOSURE

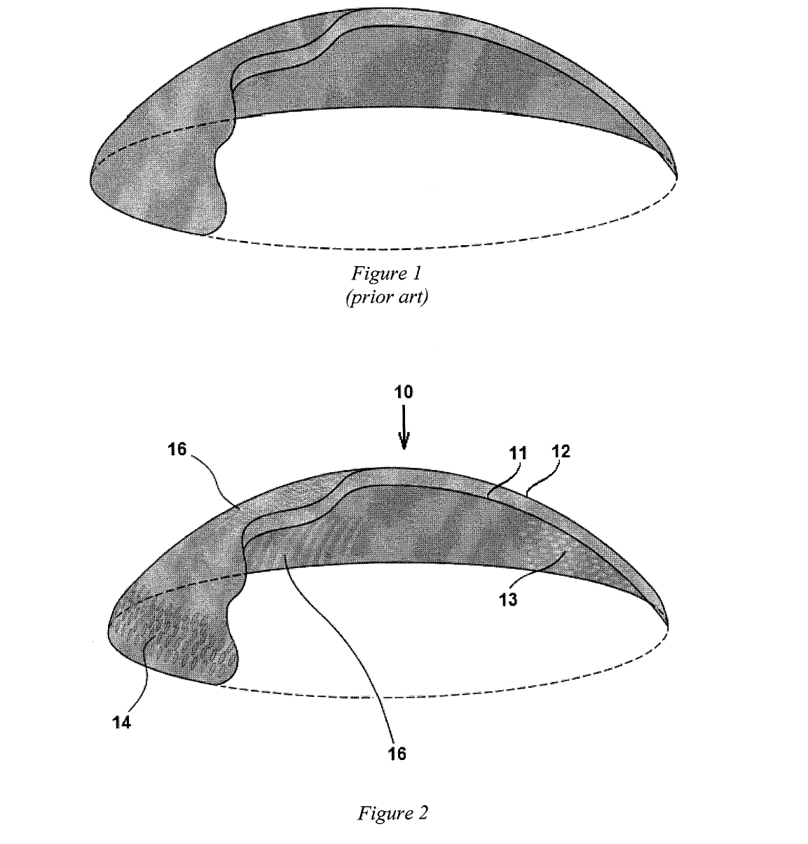

To improve lubricity and comfort in contact lenses with surface gel layers, according to embodiments of the invention, a number of topographical patterns are formed on the contact lens in the surface gel layer. As opposed to state of the art contact lenses, as shown in FIG. 1, which comprise smooth surfaces over which an eye lid must traverse with a relatively high friction, the lenses, according to an embodiment of the invention, are patterned with one or more topographical features for mitigating the pressure distribution and friction by patterns that decrease contact and control the manner of fluid flow across the lens that is imposed upon blinking. These surface patterns, as shown in FIG. 2, can target regions of the contact lens 10 that have different mechanical interactions with the eye. For example: the periphery of the top surface 12 of the contact lens 10 can be patterned with micro-scale wells 14 designed to support persistent loads between sliding cycles, maximizing boundary lubrication; the central region on the outer-side 12 of the contact lens 10 can be textured with nano-scale roughness features 16 to increase wetting and reduce tear-film break up and enhancing lubricity under hydrodynamic sliding during the blink; and the central region on the under-side 11 of the contact lens is patterned with wells 14 (not shown), nano-protuberances 13, microchannels 15 or any combination thereof. The nano-scale roughness features are designed to provide a super-wetting surface. The micro-wells are designed to enhance initiation of lubrication. The micro-perturberances are bio-inspired surface patterns that enhance wetting and fluid transport. The microchannels permit an elastically driven pumping of fluid.

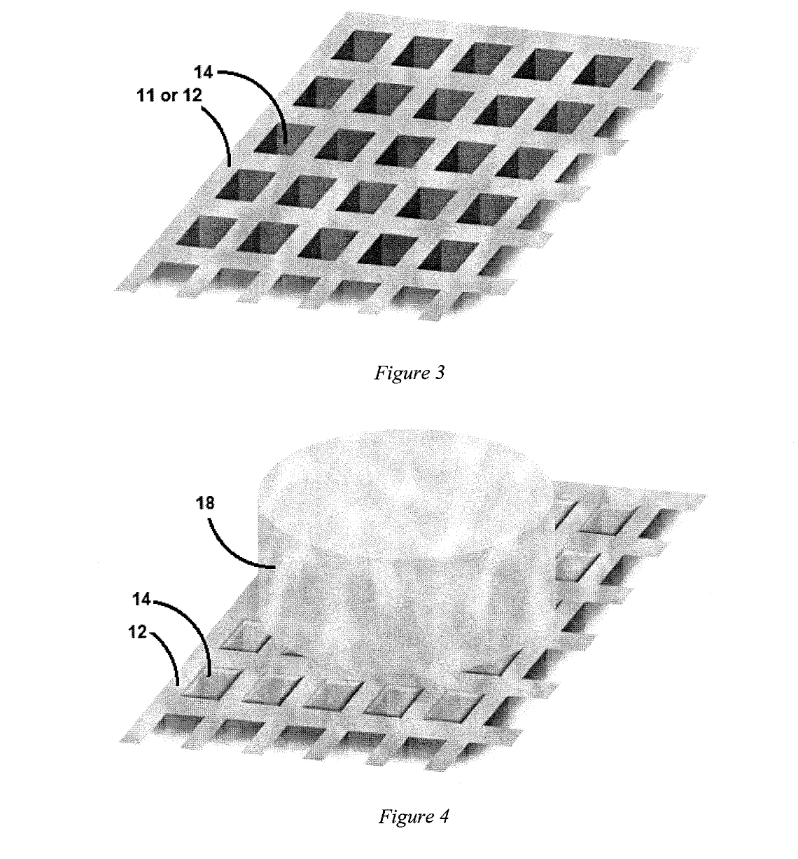

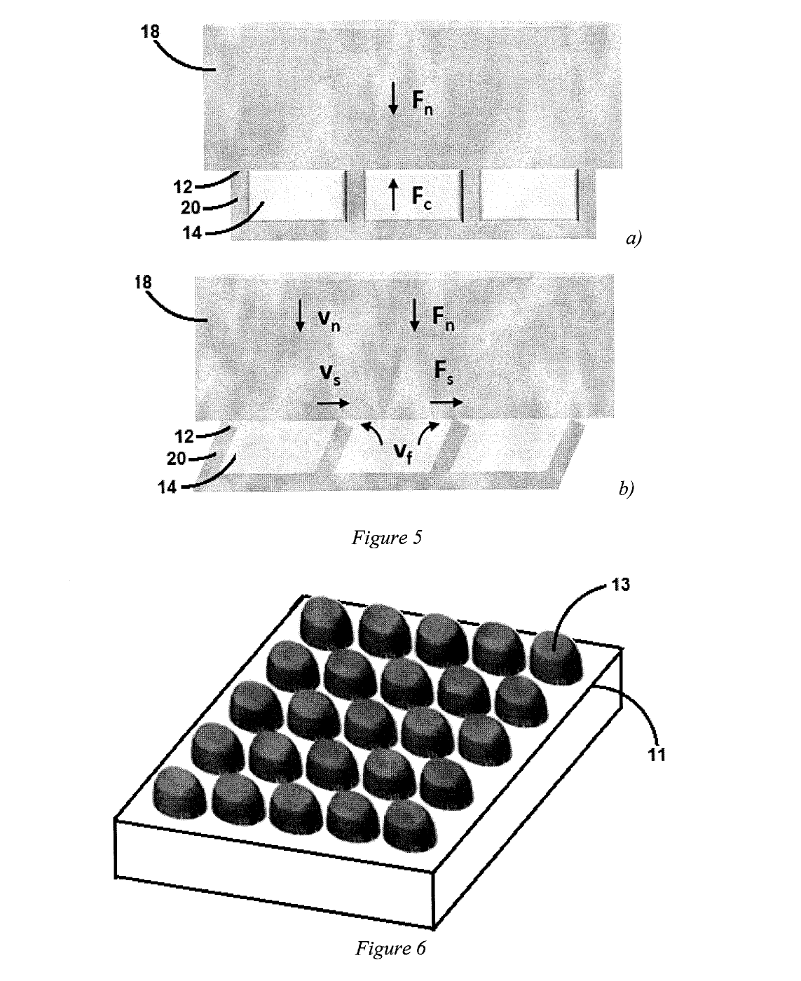

Idealized square wells 14, as illustrated in FIG. 3, provide improved lubricity due to reduced fluid transport by retaining liquid within the wells 14 and protuberances provide improved fluid transport during an increasing contact pressure that otherwise reduces lubricity. The features that define these patterns are less than 200 nm, for example, less than 100 nm, in depth to eliminate the possibility of undesired light scattering. As illustrated in FIG. 4, a supported mass 18, such as the eyelid, sits upon the micro-well array, which can deform under the force imposed by the mass 18. The shear weeping mechanism of this lubrication is illustrated in FIG. 5. As shown in FIG. 5a, with a static supported mass 18, the downward force, Fₙ, is balanced by the force imposed upon compression, F_{c}, by the flexible micro-well walls 20 on the lenses with an entrapped fluid in wells 14, which can be considered incompressible under the conditions of the lenses on the eye. When the supported mass 18 transverses the micro-well array, as shown in FIG. 5b, the walls 20 of the micro-wells 14 deform under the imposed shear to further reduce the contact between the array and to force lubricating fluid to the interface 22 of the moving supported mass and the array to increase lubricity and reduce friction between the surfaces at the interface 22. Hence, the approximate contact pressure of 5 kPa imposed between an eyelid and a contact lens comprising the micro-wells causes a desired deformation during a blink to reduce the friction and increase the lubricity.

The protuberances 13 on the surface 11 of regions of the lenses, according to an embodiment of the invention, are illustrated in FIG. 6. These protuberances 13 are positioned on the lens where increased wetting and fluid transport is paramount.

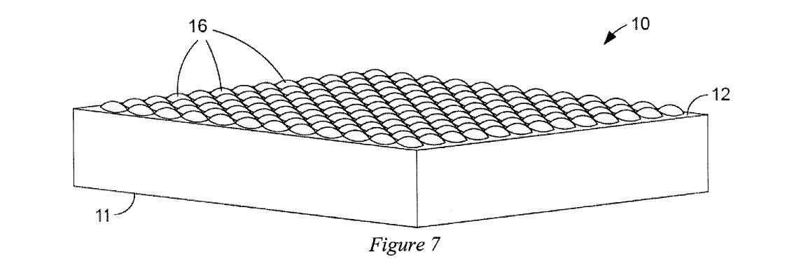

FIG. 7 shows an idealized perspective view of nano-scale roughened features 16 on a surface 12, according to an embodiment of the invention, at a region of the contact lens 10. As shown in FIG. 7, the outer surface 12 of the lens 10 displays a nano-scale surface roughness due to multiple three-dimensional surface features 16 that extend upward from the outer surface 12. The inner surface 11 can have nano-scale roughness features in addition to or alternatively to the protuberances 13, which are generally, but not necessarily, more regular than is required of nano-scale roughness features 16. As is shown in FIG. 7, the surface features 16 can be viewed as hemispherical bumps that form a pattern, although the features 16 need not be hemispherical in shape or form any pattern, and as can be conveniently formed can have varied shapes of varied sizes in a random pattern.

The nano-scale roughness features 16 increase the surface area of the region of the contact lens where they reside. The greater surface area increases the adhesive energy between the tear film and the surface relative to a smooth lens surface, which, therefore, decreases dewetting assuming that the two surfaces are of like material. In an embodiments of the invention, each surface feature 16 has height and width dimensions that range from approximately 10 to 200 nm. In an embodiment of the invention, no dimension of the features 16 is greater than one-half of the shortest wavelength of visible light to avoid Rayleigh scattering. In an embodiment of the invention, the surface features 16 are packed together with high packing density and may cover any portion of the outer surface 12 of the lens. For example, there can be one feature 16 provided for every square 10,000 nm of lens surface. In an embodiment of the invention, the surface of the lens can have, for example, a roughness factor R_{f} of approximately 2 or more, where R_{f} is the ratio of the real surface area to the geometric surface area for the surface absent the nano-scale surface roughness features.

A major factor determining the friction forces at the start of a blink is the extent to which the resting eyelid pressure compresses the lens surface gel to force fluid out of the polymer network. The timescale for this poro-elastic process depends on the mesh size of the hydrogel polymer network and the viscosity of the solvating fluid. During this slow compression process, the evolution of the contact area between the eyelid and the gel plays a key role in the break-loose force that is involved with tissue irritation. Friction forces at low contact pressure over relatively local areas of contact of 0.05 mm² or below are well below 1 mN.

Optimal surface topography of the contact lens results in increased lubricity and comfort from the generated surface patterned hydrogels. According to an embodiment of the invention, nano-scale and micro-scale textures are formed by casting and curing hydrogels on molds that possess the negative of the target topography for the lens. The molds' micro-scale topographies are generated by, but are not limited to, photolithography methods, in which patterns are made by UV curing photoresist polymer layers through photomasks. Photopatterning features, down to the scale of a single micrometer, can be prepared with common equipment for photolithography. Hydrogels can be cast onto the photoresist negative molds and released through a combination of sonication and swelling or shrinking the hydrogel in the appropriate solvent. By these photopatterning methods, one can form micro-scale fluid capturing depressions, microscale protuberances to enhance wetting and fluid transport, and long micro-channels for directed pressure driven pumping of fluids. Feature dimensions across the surface of the lens, spanning a range from sub-micron to hundreds of microns can be formed. Feature width and spacing can be independently tuned. In an embodiment of the invention, nano-scale topographies in hydrogels are formed by casting and curing on negative molds. The negative molds cannot be made through normal photolithographic methods because the target feature sizes are below the diffraction limit of visible light. In an embodiment of the invention, the nano-texturing method employs plasma-etching. Rigid polymeric substrates, such as, but not limited to, polyetheretherkeytone (PEEK), or polymethylmethacrylate (PMMA), can be exposed to a high-power O₂ plasma for a duration of several seconds to several minutes. The roughness of the textured surface scales linearly with the product of the plasma power and the treatment time, which is proportional to the total energy expended to generate the plasma for a given treatment. Because of this simple relationship, a controlled etching protocol can be defined and employed. In another embodiment of the invention, the nano-texturing protocol is employed with borosilicate or other glass substrates using Sulfur hexafluoride (SF₆) plasma, which exploits the fluorine component of the plasma to etch the glass aggressively. By casting and curing hydrogels on the nano-textured molds, and releasing the textured hydrogel, for example, by bath-sonication in an appropriate solvent, the patterned lens is formed. These lenses show a substantial improvement in surface wetting of hydrogels molded in this way relative to smooth lenses. A desired wettability of the lens can be imposed by control of the hydrogel formulation parameters, such as polymer concentration, cross-linking density, and the polymer species.

In another embodiment of the invention, the nano-scale roughness features can be formed by patterning a polymer, glass, or metal mold that is used to cast the contact lenses, where the template features are formed using other vapor phase etching techniques, liquid phase etching techniques, deposition of rough films, and/or deposition of nanoparticles on the surface of a mold.

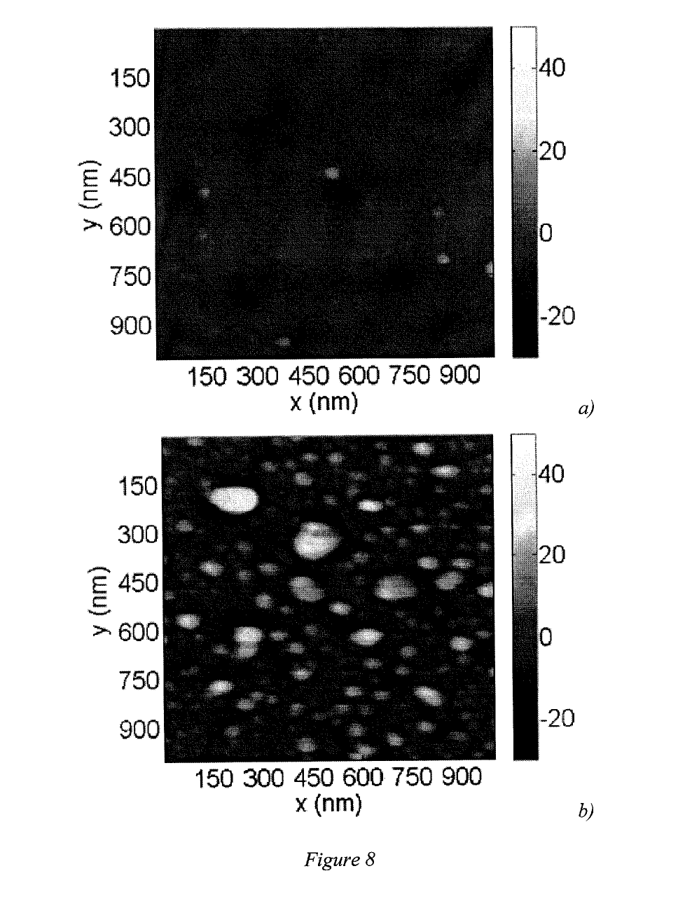

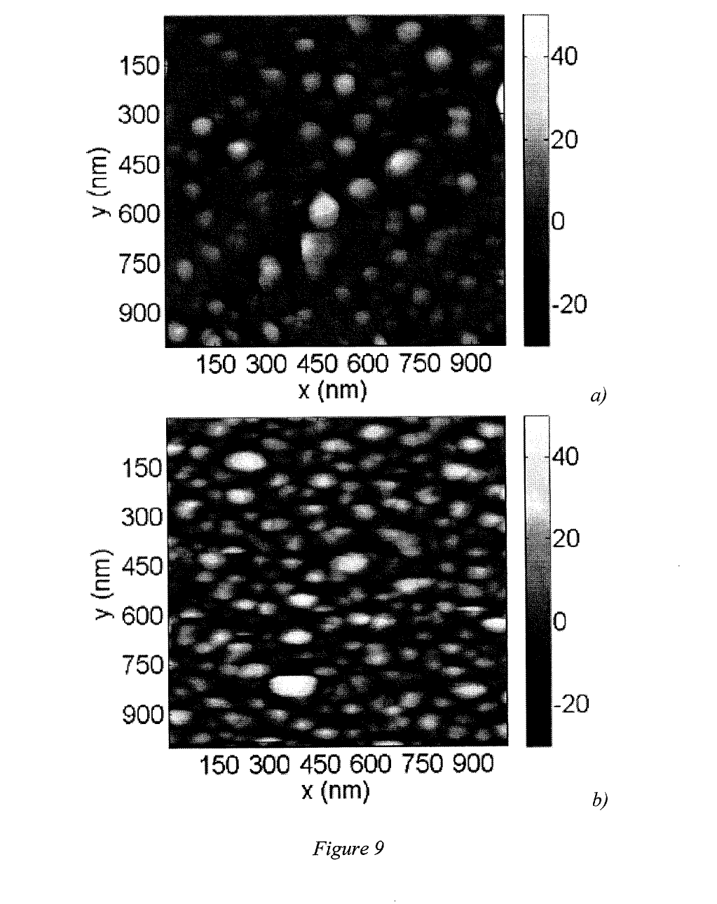

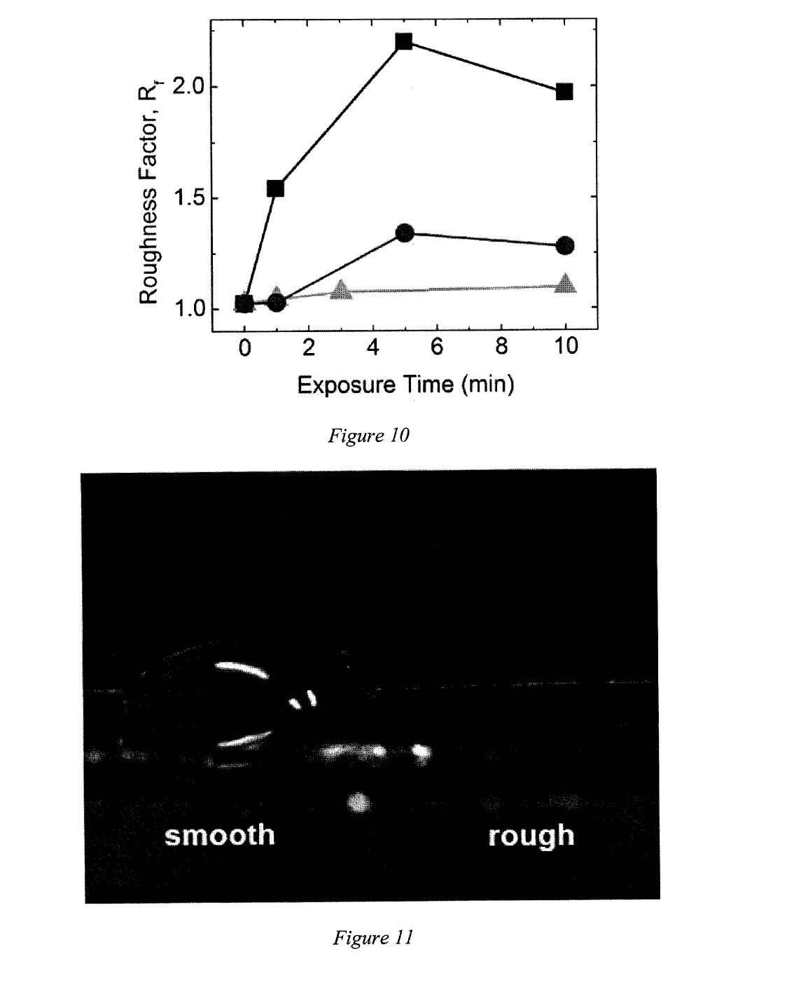

FIG. 8 shows atomic force microscopy images of a polyetheretherketone (PEEK) material after 1 minute of oxygen plasma etching at a) 10W and b) 40W. As shown in FIG. 8, the power used during the etching process has a significant effect on the surface features that are formed. FIG. 9 shows atomic force microscopy images of the PEEK material after 5 minutes of oxygen plasma etching at a) 10W and b) 40W, which when viewed with those of FIG. 8, show that the surface roughness can be controlled by either the power of the plasma or the period of exposure to the plasma. FIG. 10 is a graph of surface roughness of a PEEK material versus time for varying plasma power of 7W (triangles), 10W (circles), and 40W (squares), where it illustrates that an optimal exposure time to an oxygen plasma exists for any given plasma power.

FIG. 11 illustrates how the nano-scale roughness improves wettability. In FIG. 11, a photograph of a poly(2-hydroxyethyl methacrylate) (pHEMA) hydrogel cast on a PEEK mold with a smooth side (left) and a nano-scale rough side (right) displays dramatically different wetting characteristics. Clearly, fluid deposited on the smooth side beads water due to dewetting while no such beading occurs on the nano-scale rough side.

In an embodiment of the invention, the hydrogel lenses comprise silicone hydrogels. Suitable silicone hydrogel materials that can be employed include, without limitation, silicone hydrogels made from silicone macromers such as the polydimethylsiloxane methacrylated with pendant hydrophilic groups described in U.S. Pat. Nos. 4,259,467; 4,260,725 and 4,261,875; or the polydimethylsiloxane macromers with polymerizable functional described in U.S. Pat. Nos. 4,136,250; 4,153,641; 4,189,546; 4,182,822; 4,343,927; 4,254,248; 4,355,147; 4,276,402; 4,327,203; 4,341,889; 4,486,577; 4,605,712; 4,543,398; 4,661,575; 4,703,097; 4,740,533; 4,837,289; 4,954,586; 4,954,587; 5,034,461; 5,070,215; 5,260,000; 5,310,779; 5,346,946; 5,352,714; 5,358,995; 5,387,632; 5,451,617; 5,486,579; 5,962,548; 5,981,615; 5,981,675; and 6,039,913. The silicone hydrogels can also be made using polysiloxane macromers incorporating hydrophilic monomers such as those described in U.S. Pat. Nos. 5,010,141; 5,057,578; 5,314,960; 5,371,147 and 5,336,797; or macromers comprising polydimethylsiloxane blocks and polyether blocks such as those described in U.S. Pat. Nos. 4,871,785 and 5,034,461.

Silicone-containing monomers that may be used in the formulation of a silicone hydrogel, according to an embodiment of the invention, include oligosiloxanylsilylalkyl acrylates and methacrylates containing from 2-10 Si-atoms. Typical representatives include: tris(trimethylsiloxysilyl)propyl (meth)acrylate, triphenyldimethyl-disiloxanylmethyl (meth)acrylate, pentamethyl-disiloxanylmethyl (meth)acrylate, tert-butyl-tetramethyl-disiloxanylethyl (meth)acrylate, methyldi(trimethylsiloxy)silylpropyl-glyceryl (meth)acrylate; pentamethyldisiloxanylmethyl methacrylate; heptamethylcyclotetrasiloxy methyl methacrylate; heptamethylcyclotetrasiloxy-propyl methacrylate; (trimethylsilyl)-decamethylpentasiloxypropyl methacrylate; and dodecamethylpentasiloxypropyl methacrylate.

Other representative silicon-containing monomers which may be used for silicone hydrogels, according to an embodiment of the invention, include silicone-containing vinyl carbonate or vinyl carbamate monomers such as: 1,3-bis[4-vinyloxycarbonyloxy-but-1-yl]tetramethyldisiloxane; 3-(trimethylsilyl)propylvinylcarbonate; 3-(vinyloxycarbonylthio) propyl-[tris(trimethylsiloxy)silane]; 3-[tris(trimethylsiloxy)silyl] propyl vinyl carbamate; 3-[tris (trimethylsiloxy)silyl]propylallylcarbamate; 3-[tris(trimethylsiloxy)silyl]propylvinyl carbonate; t-butyldimethylsiloxethyl vinyl carbonate; trimethylsilylethyl vinyl carbonate; and trimethylsilylmethylvinylcarbonate. Polyurethane-polysiloxane macromonomers (also sometimes referred to as prepolymers), which have hard-soft-hard blocks like traditional urethane elastomers, may be used. Examples of such silicone urethanes that may be included in the formulations of the present invention are disclosed in a variety or publications, including Lai, “The Role of Bulky Polysiloxanylalkyl Methacrylates in Polyurethane-Polysiloxane Hydrogels,” Journal of Applied Polymer Science, Vol. 60, 1193-1199 (1996).

Suitable hydrophilic monomers, which may be used separately or in combination for the silicone hydrogels of the present invention non-exclusively include, for example: unsaturated carboxylic acids, such as methacrylic and acrylic acids; acrylic substituted alcohols, such as 2-hydroxyethylmethacrylate, 2-hydroxyethylacrylate (HEMA), and tetraethyleneglycol dimethacrylate (TEGDMA); vinyl lactams, such as N-vinyl pyrrolidone; vinyl oxazolones, such as 2-vinyl-4,4′-dimethyl-2-oxazolin-5-one; and acrylamides, such as methacrylamide and N,N-dimethylacrylamide (DMA). Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Hydrophilic monomers may be incorporated into such copolymers, including, methacrylic acid and 2-hydroxyethyl methacrylamide.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

1. A surface patterned contact lens, comprising a hydrogel or silicon hydrogel, wherein one or more surface regions, each has a multiplicity of nano-scale roughness features, micro-wells, micro-protrusions, or micro-channels.

2. The surface patterned contact lens according to claim 1, wherein the micro-wells, micro-protrusions, and/or micro-channels have a depth or height of 20 to 200 nm, and dimensions parallel to the surface of 100 μm or less.

3. The surface patterned contact lens according to claim 1, wherein the multiplicity of nano-scale roughness features provide the surface region with a roughness factor R_{f} of 2 or more.

4. The surface patterned contact lens according to claim 1, wherein the multiplicity of nano-scale roughness features have dimensions of 10 to 200 nm.

5. The surface patterned contact lens according to claim 1, wherein the surface region at the periphery of the top surface comprises the micro-wells.

6. The surface patterned contact lens according to claim 1, wherein the surface region at the center of the top surface comprises the nano-scale roughness features.

7. The surface patterned contact lens according to claim 1, wherein surface regions at the under-side the contact lens is patterned with the nano-scale roughness features, the micro-wells, the nano-protuberances, and/or the microchannels.

8. A method of preparing a surface patterned contact lens, comprising:
providing an inner mold and an outer mold;
casting hydrogel or silicon hydrogel precursors on the inner mold or outer mold;
positioning the outer mold or inner mold, respectively, on the cast silicon hydrogel precursors, and
curing the hydrogel or silicon hydrogel precursors to a surface patterned hydrogel or silicon hydrogel lens, wherein the inner mold and/or outer mold comprises one or more surface regions comprising a template for nano-scale roughness features, micro-wells, micro-protrusions, or micro-channels, and wherein the hydrogel lens or silicone hydrogel lens has at least one surface region having patterns for nano-scale roughness features, micro-wells, micro-protrusions, or micro-channels.
